(19) United States
(12) Patent Application Publication
(10) Pub. No.: US 2004/0115500 A1
(43) Pub. Date: Jun. 17, 2004

(54) Polymer electrolyte fuel cell and power-generating system with polymer electrolyte fuel cells

(76) Inventors: Yasuji Ogami, Yokohama-Shi (JP); Atsushi Ooma, Yokohama-Shi (JP); Akio Kano, Yokohama-Shi (JP); Atsuo Sonai, Yokohama-Shi (JP); Michio Hori, Yokohama-Shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/730,936

(22) Filed: Dec. 10, 2003

Related U.S. Application Data
(63) Continuation of application No. PCT/JP01/05152, filed on Jun. 15, 2001.

(51) Int. Cl. H01M 8/10; H01M 8/04; H01M 8/24

(52) U.S. Cl. 429/32; 429/38; 429/26; 429/23

(57) ABSTRACT

To render a polymer electrolyte fuel cell and a power-generating system with polymer electrolyte fuel cells, simple, compact and lightweight, the following measures are taken. A plurality of reactant-gas supplying separator are provided, each on at least one surface of each unit cell. Each reactant-gas supplying separator has fuel-gas supplying passages such as grooves in one surface, and oxidizer-gas supplying passages such as grooves in the other surface. Each unit cell comprises a catalyst layer and an electrically conductive, porous water-repellant layer provided at least between the catalyst layer and the grooves. The system comprises water-supplying means for supplying water in liquid state to a fuel-gas inlet section and a water-amount control means for controlling the amount of water to be supplied to the fuel-gas inlet section.

### CROSS-REFERENCE TO RELATED APPLICATIONS

This is a Continuation Application of PCT Application No. PCT/JP01/05152, filed Jun. 15, 2001, which was not published under PCT Article 21(2) in English.

### BACKGROUND OF THE INVENTION

1. Field of the Invention

The present invention relates to a polymer electrolyte fuel cell using a proton exchange membrane as electrolyte and also to a power-generating system with polymer electrolyte fuel cells.

2. Description of the Related Art

Fuel cells are devices in which fuel gas such as hydrogen electrochemically reacts with oxidizer gas such as air to convert the chemical energy of fuel gas to electric energy.

FIG. 12 is a conceptual sectional view for explaining a conventional polymer electrolyte fuel cell that is one example of a fuel cell. The fuel-cell main unit 11 of the fuel cell comprises a plurality of basic units 01 that are mechanically laid one on another and electrically connected in series. Each basic unit 01 comprises a unit cell 4, a gas-impermeable fuel-gas supplying separator 5, a gas-impermeable oxidizer supplying separator 6, and a cooling-water supplying separator 7. The unit cell 4 comprises a sheet of proton exchange membrane 1, a fuel electrode (pole) 2, and an oxidizer electrode (pole) 3. The fuel electrode 2 is composed of a substrate 41 and a catalyst layer 42. The oxidizer electrode 3 is composed of a substrate 43 and a catalyst layer 44. The fuel electrode 2 and the oxidizer electrode 3 are provided on the proton exchange membrane 1 (with the catalyst layers 42 and 43 contacting the proton exchange membrane 1). The gas-impermeable fuel-gas supplying separator 5 is electrically conductive, abuts on the fuel electrode 2 and has fuel-gas supplying grooves 46 for supplying reactant-gas to the fuel electrode 2. The cooling-water supplying separator 7 abuts on the fuel-gas supplying separator 5 and has cooling-water supplying grooves 47. The gas-impermeable oxidizer supplying separator 6 is electrically conductive, abuts on the oxidizer electrode 3 and has oxidizer-gas supplying grooves 48 for supplying reactant-gas to the oxidizer electrode 3.

The fuel gas consisting mainly of hydrogen is supplied to the fuel electrode 2 and the oxidizer gas such as air is supplied to the oxidizer electrode 3. Then, the following electrochemical reaction proceeds at the electrodes of the unit cell 4, generating electromotive force between the electrodes 2 and 3.

Fuel electrode: 2H₂→4H⁺+4e⁻ (2)

Oxidizer electrode: O₂+4H⁺+4e⁻→2H₂O (3)

In the catalyst layer 42 of the fuel electrode 2, the hydrogen supplied dissociates into hydrogen ions and electrons as expressed in the formula (2). The hydrogen ions move to the oxidizer electrode 3, passing through the proton exchange membraneproton exchange membrane 1. The electrons move to the oxidizer electrode 3, passing through an external circuit.

In the catalyst layer 44 of the oxidizer electrode 3 the oxygen in the oxidizer gas supplied reacts with the hydrogen ions and the electrons, forming water, as indicated in the formula (3). At this time, the electrons that have passed the external circuit form electric current. Thus, the unit cell 4 can supply electric power.

The water formed through the reactions of the formulas (2) and (3) is discharged from the fuel cell, together with the gas that has not been used in the fuel cell. The reaction of the formula (3) is a exothermic reaction. The fuel-cell main unit 11 therefore generates heat.

Generally, the fuel-cell main unit 11 is cooled by passing cooling water through the cooling-water supplying separator 7 or by using a latent-heat cooling system that utilizes water vapor at the oxidizer electrode 3. This system will be described later.

The proton exchange membrane 1 is, as is known, made of ion-conducting perfluorocarbon sulfonic acid (Nafion R, Dupont, U.S.A.) or the like. The membrane 1 is characterized in that the molecules have an exchange group for hydrogen ion. The membrane 1 functions as ion-conducting electrolyte when its water content is saturated. When its water content decreases, increasing its ionic resistance, the membrane 1 has its electrolytic performance reduced. To impart high performance to the polymer electrolyte fuel cell, the proton exchange membrane 1 must preserve saturated water content.

The conventional power-generating system with polymer electrolyte fuel cells will be described, with reference to the system diagram of FIG. 13. In FIG. 13, the valves for controlling fluids or the devices for measuring temperatures and pressures are not illustrated.

The configuration of the system will be described. Hydrocarbon, such as methanol, may be used as fuel for generating electric power. In this case, the hydrocarbon should react with water vapor in a reformer 10 to convert the hydrogen to fuel gas that contains mainly hydrogen. The fuel gas thus prepared is supplied to the fuel-cell main unit 11. Some of the hydrogen is consumed in the fuel-cell reaction. The remaining hydrogen not consumed, the inert gas such as CO₂, and the water vapor are discharged as reacted gases, from the fuel-cell main unit 11.

The reacted gases are cooled by a cooler 15 at the outlet port of the fuel cell. The gases are combusted in the reformer 10 after water is recovered from them. Pure hydrogen can be used as fuel. If this, the hydrogen can be supplied directly to the fuel cell and the reformer 10 can be dispensed with. This renders the system comparatively simple.

The pressure of air, which is usually used as oxidizer, is raised by, for example, a blower 14. The air is applied at high pressure to the fuel-cell main unit 11. The air needs to be humidified before applied to the fuel-cell main unit 11. This is why a humidifier 12 is provided on the line for supplying the oxidizer gas.

After oxygen has been used in the fuel-cell main unit 11, the reacted gases, the water formed, and the water vapor moving from the fuel electrode are discharged from the fuel-cell main unit 11. The cooler 15 cools the reacted gases at the outlet port of the fuel cell. The gases are discharged into the atmosphere after a drain pot 16 has recovered the water.

The fuel-cell main unit 11 generates heat as it generates electric power. A water-supplying system 13 supplies cooling water. The cooling water passes through a cooling plate 17 and the humidifier 12. It then flows back to the water-supplying system. Thus, it cools the fuel-cell main unit 11. The heat collected from the reacted gases and cooling water may heat water to supply hot water.

Water should be preserved by all means in the power-generating system with polymer electrolyte fuel cells. Therefore, the water contained in the reacted gases discharged from the fuel-cell main unit 11 is recovered. The water recovered is used to reform the fuel, humidify the air and cool the fuel-cell main unit.

The conventional technique is disadvantageous in the following respects.

(a) In the system wherein reactant gases are humidified before they are supplied to the fuel-cell main unit, the water recovered from the reacted gases in the fuel cell is used to humidify the reactant gases. The humidifier 12 needs to vaporize a large amount of water in the reactant gases. A proportional quantity of heat (latent heat of evaporation) must be applied to the water. To this end, the humidifier 12 should be a large one. This makes it difficult to render the power-generating system compact and lightweight.

(b) In the system wherein the operating temperature of the fuel-cell main unit 11 is controlled by circulating the cooling water, a large water-supplying system 13 (pump, drain pot, etc.) is required to circulate much cooling water in order to control the temperature. Further, the cooling-water supplying separator 7, which is incorporated in the fuel-cell main unit 11 but does not contribute to the generation of power, is indispensable. Consequently, the fuel-cell main unit is massive. This makes it difficult to render the power-generating system compact, lightweight and inexpensive.

Accordingly, a first object of the present invention is to provide a polymer electrolyte fuel cell in which the proton exchange membrane can be prevented from being dried even if the reactant gases are not humidified and no system is required to circulate cooling water, and which can reliably generate electric power stably even when the load is large or when the load changes.

A second object of the present invention is to provide a polymer electrolyte fuel cell which is inexpensive, which comprises a plurality of unit cells laid one on another, and in which water is uniformly supplied to the unit cells.

A third object of the present invention is to provide a power-generating system with polymer electrolyte fuel cells, which can reliably generate electric power even if the load changes.

### BRIEF SUMMARY OF THE INVENTION

According to a first aspect of the present invention, there is provided a polymer electrolyte fuel cell that comprises: a plurality of unit cells each having a proton exchange membrane, a fuel electrode provided on one surface of the membrane and having a catalyst layer, and an oxidizer electrode provided on the other surface of the membrane and having a catalyst layer; a reactant-gas supplying separator having fuel-gas supplying passages for supplying fuel gas to the fuel electrode of each unit cell; a water-repellant layer which is electrically conductive and porous and which is provided between the catalyst layer of the fuel electrode and the reactant-gas supplying separator; and water-supplying means for supplying water in liquid state to the fuel-gas supplying passages.

According to the first aspect of the invention, part of the water supplied together with the fuel gas changes to water vapor in the fuel-gas supplying grooves. The water vapor flows through a porous member provided in the fuel electrode, reaching the catalyst layer. In the catalyst layer of the fuel electrode, the water vapor condenses and changes to water, as the fuel gas is consumed. The water flows through the proton exchange membrane, moves to the oxidizer electrode and evaporates at the oxidizer electrode. The proton exchange membrane therefore remains wet. This makes it unnecessary to humidify the oxidizer gas.

The electrically conductive, porous water-repellant layer plays an important role. That is, the water-repellant layer allows passage of water vapor, but prevents water (liquid) from passing through it. Thus, water can be supplied in a sufficient amount to evaporate at the oxidizer electrode. Further, it is possible to avoid a voltage drop that may results from excessive wetting of the catalyst layer. Rather much water can be supplied to cope with greatly changes of load. Hence, the fuel cell can operate in a stable condition even when the load greatly changes.

According to a second aspect of the invention, there is provided a polymer electrolyte fuel cell that comprises: a plurality of unit cells each having a proton exchange membrane, a fuel electrode provided on one surface of the membrane and having a catalyst layer, and an oxidizer electrode provided on the other surface of the membrane and having a catalyst layer; a reactant-gas supplying separator having fuel-gas supplying passages for supplying fuel gas to the fuel electrode of each unit cell; a water-repellant layer which is electrically conductive and porous and which is provided between the catalyst layer of the fuel electrode and the reactant-gas supplying separator; and humidifying/latent heat cooling means for humidifying the proton exchange membrane by supplying water in liquid state to the fuel-gas supplying passages and for performing latent heat cooling on the reactant-gas supplying separator.

According to the second aspect of the invention, the water moving from the fuel electrode and the water generated in the cell reaction evaporate at the oxidizer electrode. When the water evaporates, it absorbs evaporation latent heat of about 538 cal/g. The oxidizer gas therefore absorbs the heat generated in the cell reaction. Thus, the oxidizer gas achieves latent heat cooling on the fuel-cell unit before it is discharged from the fuel-cell unit. The efficiency of the latent heat cooling depends on how much water evaporates in the fuel-cell unit. Namely, the higher the temperature of the fuel-cell unit, the greater the difference between the temperature of the fuel-cell unit and the dew point of the oxidizer gas supplied, and the lower the use ratio of the oxidizer gas, the larger the amount of water that evaporates to enhance the efficiency of the latent heat cooling.

Therefore, the latent heat cooling is weak when the temperature of the fuel-cell unit is low, provided that the dew point of the oxidizer gas supplied and the use ratio of the oxidizer gas remain constant. In this case, the temperature of the fuel-cell unit will rise. When the temperature of the fuel-cell unit sufficiently rises, the latent heat cooling becomes prominent. The amount of the heat generated by the fuel-cell unit eventually balances with the degree of the latent heat cooling. As a result, the temperature of the fuel-cell unit becomes constant.

The operating conditions, such as the dew point of oxidizer gas, the load current, the use ratio of reactant-gas and the ambient temperature, may change. Even if so, the temperature of the fuel-cell unit changes until the heat generated balances with the degree of the latent heat cooling and finally becomes constant. No means are therefore required to control the temperature of the fuel-cell unit. Nor is it necessary to control the temperature of the water supplied, for two reasons. First, the evaporation latent heat is far greater than the sensible heat of water. Second, the amount of water supplied to the fuel-cell unit is extremely small.

However, the temperature of the fuel-cell unit will rise too much unless water is supplied to the fuel-cell unit in an amount large enough to achieve sufficient latent heat cooling. Means for controlling the amount of water is therefore important, which controls the amount of water that cools the fuel-cell unit.

Thus, the fuel-cell unit can be simple, compact and lightweight and can be manufactured at low cost.

As specified above, the polymer electrolyte fuel cell according to the second aspect of the invention has a plurality of unit cells laid one upon another. In each unit cell, water is supplied to the fuel electrode, preventing the proton exchange membrane from being dried. Thus, the reactant gases need not be humidified beforehand. In addition, no large cooling-water circulating systems are required. The fuel cell can yet operate in a stable condition to generate electric power even if the load is large or changes. Should the load greatly change, latent heat cooling can be achieved by supplying water to the fuel-cell unit in an appropriate amount. This makes it possible to provide a power-generating system that can operate in a stable condition to generate electric power.

According to a third aspect of the present invention, there is provided a polymer electrolyte fuel cell of the type according to the first or second aspect of the invention has the following configuration. The fuel cell further comprises water-amount control means for controlling the amount of water to be supplied to the fuel-gas supplying passages.

According to a fourth aspect of the present invention, there is provided a polymer electrolyte fuel cell of the type according to any one of the first to third aspects. This fuel cell has the following configuration. That is, the water-supplying means or the humidifying/latent heat cooling means comprises a water manifold which passes through at least the reactant-gas supplying separator, a header which is provided in a fuel-gas inlet section provided in the reactant-gas supplying separator and which mixes fuel gas with water, and a water-supplying section which is the reactant-gas supplying separator and which connects the header and the water manifold.

According to the fourth aspect of the invention, the water supplied from outside the fuel cell to the water manifold through the reactant-gas supplying separator passes through the water-supplying passages and flows into the header that is provided at the fuel-gas inlet section of each unit cell. In the header, the water is mixed with the fuel gas supplied. The resultant mixture fluid is uniformly distributed to the fuel-gas supplying passages. Thus, the water can be uniformly supplied to the fuel-gas supplying passages of the unit cells that are stacked in the fuel-cell unit. The water-supplying passages (water-supplying means) are made in at least one surface of the reactant-gas supplying separator at the same time gas-supplying passages are made in the reactant-gas separator. The water-supplying means can, therefore, be provided at a very low cost.

According to a fifth aspect of the present invention there is provided a polymer electrolyte fuel cell of the type according to any one of first to third aspects. This fuel cell has the following configuration. The water-supplying means or the humidifying/latent heat cooling means comprises a water manifold which passes through at least the reactant-gas supplying separator, a header which is provided in a fuel-gas inlet section provided in the reactant-gas supplying separator and which mixes fuel gas with water, a porous member which is the reactant-gas supplying separator and arranged in the header as a pressure-loss element, and a water-supplying passage section which is the reactant-gas supplying separator and which connects the header and the water manifold.

According to the fifth aspect of the invention, the water supplied from outside the fuel cell to the water manifold through the reactant-gas supplying separator passes through the water-supplying passages and flows into the header that is provided at the fuel-gas inlet section of each unit cell. In the header, the water is mixed with the fuel gas supplied. The resultant mixture fluid passes through the porous member and is distributed to the fuel-gas supplying passages. As the mixture of the water and fuel gas passes through the porous member, a pressure loss develops. Due to the pressure loss, the mixture fluid spreads in a direction perpendicular to is flowing direction. Thus, the mixture fluid is uniformly distributed to the fuel-gas supplying passages.

According to a sixth aspect of the present invention, there is provided a polymer electrolyte fuel cell of the type according to any one of the first to third aspects. This fuel cell has the following configuration. Namely, the water-supplying means or the humidifying/latent heat cooling means comprises a water manifold which passes through at least the reactant-gas supplying separator, fuel-gas supplying passages made in one surface of the reactant-gas supplying separator, a header which is provided in a fuel-gas inlet section provided in the reactant-gas supplying separator and which mixes fuel gas with water, a water-supplying passage which is the reactant-gas supplying separator and which connects the header and the water manifold, and a porous member which is the reactant-gas supplying separator and which is arranged, as a pressure-loss element, in the water-supplying passage.

According to the sixth aspect of the present invention, the water supplied from outside the fuel cell to the water manifold through the reactant-gas supplying separator passes through the porous member provided in the water-supplying passage and flows into the header that is provided at the fuel-gas inlet section of each unit cell. In the header, the water supplied is mixed with the fuel gas supplied. The resultant mixture fluid is distributed to the fuel-gas supplying passages.

Since the water coming from the water manifold via the porous member provided in the water-supplying passage is supplied to the header, it can be dispersed in the header and uniformly mixed with the fuel gas. Thus, the mixture fluid can be uniformly supplied to the fuel-gas supplying passages. As the mixture of the water and fuel gas passes through the porous member, a pressure loss is caused. This makes it possible to supply the water uniformly to the unit cells that are laid one on another.

The porous member may be a selected one that has pores of a specific average diameter. This can prevent the fuel gas from leaking into the water-supplying side thanks to the capillary force of the porous member, even if the fuel gas acquires a higher pressure than the water supplied.

According to a seventh aspect of the invention, there is provided a polymer electrolyte fuel cell of the type according to any one of first to third aspects. This fuel cell is of the following configuration. The water-supplying means or the humidifying/latent heat cooling means comprises a water manifold which passes through at least the reactant-gas supplying separator, fuel-gas supplying passages made in one surface of the reactant-gas supplying separator, a water-supplying passage which communicates with the water-supplying manifold and which is provided in that surface of the reactant-gas supplying separator which faces away from the a fuel-gas inlet section-and in which the fuel-gas supplying passages are made, and communication holes which connect the fuel-gas inlet section and the water-supplying passage.

According to the seventh aspect of the invention, the water supplied from outside the fuel cell to the water manifold through the reactant-gas supplying separator passes through the water-supplying passage. The water passes through the communication holes that are arranged in the fuel-gas inlet section. The water is then supplied to the fuel-gas inlet section. In the fuel-gas inlet section, the water mixes with the fuel gas supplied. The resultant mixture fluid flows into the gas-supplying passages.

Since the communication holes are provided in the fuel-gas inlet section, the headers provided in the fuel-gas inlet section, too, can be smaller than otherwise. This helps to supply water uniformly into the fuel-gas supplying passages.

According to an eighth aspect of the invention, there is provided a polymer electrolyte fuel cell of the type according to any one of first to third aspects. The fuel cell has the following configuration. That is, the water-supplying means or the humidifying/latent heat cooling means comprises a water manifold which passes through at least the reactant-gas supplying separator, fuel-gas supplying passages made in one surface of the reactant-gas supplying separator, a water-supplying passage which communicates with the water-supplying manifold and which is provided in that surface of the reactant-gas supplying separator which faces away from the a fuel-gas inlet section and in which the fuel-gas supplying passages are made, communication holes which are made in the reactant-gas supplying separator and which connect the fuel-gas inlet section and the water-supplying passage; and a porous member which is used as a pressure-loss element and which covers the communication holes.

According to the eighth aspect of the invention, the headers provided in the fuel-gas inlet section can be made small as in the seventh aspect. Thus, water can be uniformly supplied to the fuel-gas supplying passages. As the mixture of the water passes through the porous member, a pressure loss develops. This makes it possible to supply the water uniformly to the unit cells that are laid one on another. The porous member may be a selected one that has pores of a specific average diameter. This can prevent the fuel gas from leaking into the water-supplying side thanks to the capillary force of the porous member, even if the fuel gas acquires a higher pressure than the water supplied.

According to a ninth aspect of the invention, there is provided a polymer electrolyte fuel cell of the type according to any one of 5th, 6th and 8th aspects. This fuel cell has the following configuration. Namely, the porous member has pores whose average diameter was 20 mm or less (excluding 0 mm).

According to the ninth aspect of the invention, the water held in the pores of the porous member attains a capillary force of 5 kPa more because they have an average diameter of 20 mm or less. Hence, the porous member achieves wet-sheet effect for the gas at a pressure difference of 5 kPa or less.

In the fuel-cell unit, the smaller the pressure loss in the fuel-gas supplying passages, the better. However, a pressure loss of about 3 kPa usually occurs when the fuel passes through each fuel-gas supplying passage. It is therefore required that the fuel gas be supplied at a higher pressure. No pressure may be available to supply water due to the malfunction of the water-supplying system. If this happens, the pressure at which the fuel gas is supplied may rise 3 kPa higher than the pressure at which the water is supplied. Nonetheless, the fuel gas will not leak into the water-supplying side even if the water-supplying system malfunctions. This is because the porous member has an average porous diameter of 20 mm or less.

According to a tenth aspect of the invention, there is provided a power-generating system with polymer electrolyte fuel cells. The system is characterized by comprising: a plurality of unit cells each having a proton exchange membrane, a fuel electrode provided on one surface of the membrane and having a catalyst layer, and an oxidizer electrode provided on the other surface of the membrane and having a catalyst layer; a reactant-gas supplying separator having fuel-gas supplying passages for supplying fuel gas to the fuel electrode of each unit cell; a water-repellant layer which is electrically conductive and porous and which is provided between the catalyst layer of the fuel electrode and the reactant-gas supplying separator; water-supplying means for supplying water in liquid state to the fuel-gas supplying passages or humidifying/latent heat cooling means for humidifying the proton exchange membrane by supplying water in liquid state to the fuel-gas supplying passages and for performing latent heat cooling on the reactant-gas supplying separator; heat-recovering means for recovering heat of water from exhausted fuel gas and oxidizer exhaust gas which are discharged from the unit cells; recovered-water supplying means for supplying the water recovered in the heat-recovering means; and water-amount control means for controlling an amount of water supplied from the recovered-water supplying means.

According to the tenth aspect of the present invention, water is recovered from the fuel gas and the oxidizer gas, both discharged from the polymer electrolyte fuel-cell unit in which water is supplied to the fuel electrode to perform latent heat cooling. The water recovered is supplied to the fuel electrode, along with the fuel gas. In any polymer electrolyte fuel-cell unit, wherein water is supplied to the fuel electrode to latent heat cooling, the exhausted fuel gas contains as much water as the exhausted oxidizer gas. Thus, water required can be obtained by recovering water from both gases exhausted.

The amount of water that should be supplied to the fuel electrode depends on the amount of heat the cell unit generates. If the amount of water supplied is too small, the latent heat cooling cannot be as efficient as is desired. If the amount of water supplied is too large, the operating efficiency of the system will fall. Thus, the amount of water to supply is controlled to enable the system to operate at a stable high efficiency.

The tenth aspect of the invention achieves the following advantages:

(1) No humidifier for the oxidizer gas is required.

(2) The water-recovering system and water-supplying system can be compact and lightweight, because the cooling achieved by the latent heat is more efficient than the cooling achieved by the sensible heat of water and needs but a very small amount of water. Hence, the power-generating system can be compact and lightweight as a whole.

According to an eleventh aspect of the invention, there is provided a power-generating system with polymer electrolyte fuel cells, which is of the type according to tenth aspect. The system is of the following configuration. That is, the water-amount control means for controlling an amount of water comprises calculation means for calculating an amount of water to be supplied, from the voltage of electric power generated by each unit cell and the load current of each unit cell, and a metering pump which controls the amount of the recovered water to be supplied, in accordance with a signal representing the result of calculation performed by the calculation means.

According to the eleventh aspect of the invention, the amount of heat generated from the fuel cell unit is calculated from the voltage of the electric power generated and from the load current. The metering pump supplies water to the fuel cell unit in an amount that can be cooled by latent heat cooling. Thus, water can be supplied to the fuel cell unit, always in an optimal amount, even if the operating conditions such as the load current change. The system can therefore generates electric power in a stable condition even if the load current greatly changes. This maintains high system efficiency.

According to a twelfth aspect of the present invention, there is provided a power-generating system with polymer electrolyte fuel cells, which is of the type according to ninth to tenth aspect. This system has the following configuration. Namely, the calculation means calculates the amount W of water (g/min) in accordance with the following equation, and the water-amount control means controls the supply of water to the fuel-gas supplying passages or oxidizer-gas supplying passages, in an amount up to 20 times the value W,

W=30·I·C·(ΔH/F−2V)/h (4)

where V is the voltage of electric power (V/cell), I is the load current (A), C is the number of unit cells stacked, h is the latent heat of evaporation (J/g), ΔH is the enthalpy change (J/mol) that occurs water vapor is generated by electrochemical reaction, and F is the Faraday constant (C/mol).

According to the twelfth aspect of the invention, the amount of water required to cool the fuel cell unit by means of latent heat cooling can be obtained in using the above equation (4). The equation (4) expresses the amount of water having latent heat of evaporation that corresponds to the amount of heat (to cancel out by cooling) calculated from the voltage of the power generated and the load current on the assumption that all water formed by the cell reaction changes to water vapor. When water is supplied to the fuel cell unit in an amount greater than the value calculated on the basis of the above equation, the latent heat cooling can be performed always at a maximum efficiency. The cell characteristic remains stable no matter whether the load is high or greatly changes. If water is supplied in an amount up to 20 times the value, the unit cells will differ in output voltage. This is because hydrogen gas is supplied to the unit cells in different amounts. If the amount of water supplied is controlled to be 10 times or more the value, the system can operate in a stable condition, provided that the load changes fall within an ordinary range (10% to 100%). Thus, if water is supplied to each cell unit in an amount ranging from the value responsible for the latent heat of evaporation that corresponds to the amount of heat calculated from the voltage and load current on the assumption all water formed by the cell reaction changes to water vapor, to 20 times or less this value, the system can generates electric power in a stable condition even if the load greatly changes. Thus, the system can keep operating at high efficiency.

The above equation (4) derives from the following introductory equation:

Introductory equation:

The amount of electric charge that passes in one cell when the load current I(A) is I (C/sec). Thus, the amount of electric charge that flows for one minute is 60·I (C/min). When 1 mol of hydrogen is consumed, an electric charge of 2·F (C) is generated. Note that F (C/mol) is the Faraday constant. Therefore, the amount of hydrogen consumed in one cell is given by the following equation (5):

60·I/2F=30·I/F (5)

where I is the load current (A).

Hence, the amount M of hydrogen (mol/min) consumed in the stack composed of C cells is calculated by the following equation (6):

M=30·I·C/F (6)

where I is the load current (A), C is the number of cells, F is the Faraday constant.

The following equation (7) represents an equation in which all water generated in the cell reaction performed in the polymer electrolyte fuel cell unit changes to water vapor.

H₂ (g)+1/2 O₂ (g)→H₂O (g) (7)

The change in the enthalpy generated in the reaction of the equation (7) is ΔH (J/mol) . Then, the change U (J/min) in the total energy of the hydrogen consumed is given by the following equation (8):

U=ΔH·M=30·ΔH·I·C/F (8)

The amount (Q) of heat generated by the cell unit is obtained by subtracting the electric power from the change U (J/min) of total energy of the hydrogen consumed. Thus, the amount of heat can be calculated by using the following equation (9):

Q=U−60·I·V·C (9)

where V is the cell voltage of the unit cell, i.e., V/cell.

Let us substitute the equation (8) in the equation (9). Then:

Q=30·I·C·(ΔH/F−2·V) (10)

The amount of heat, which should be canceled by cooling, can be obtained by using the equation (10). The sensitive heat of the water supplied and the sensitive heat of the reactant-gas can cancel but a small amount of heat. In the actual plant, the fuel cell unit is thermally insulated and heat is prevented from radiating from the surfaces of the fuel cell unit. Therefore, it is necessary to supply water to the fuel cell unit, in at least such an amount as will achieve latent heat cooling to cancel the above-mentioned amount Q of heat.

The amount W (g/min) of water supplied is given:

W=Q/h (11)

where h is the latent heat of evaporation of the water. Substituting the equation (10) in the equation (11) yields:

W=30·I·C·(ΔH/F−2V)/h (12)

Here, C and F are constants, and ΔH and h can be regarded as almost constants. Hence, the minimum amount of water, which should be supplied to perform latent heat cooling on the cell unit, can be obtained from the voltage of power generated and the load current.

### BRIEF DESCRIPTION OF THE SEVERAL VIEWS OF THE DRAWING

FIG. 1 is a sectional view showing the configuration of a polymer electrolyte fuel cell according to a first embodiment of the present invention;

FIGS. 2A and 2B are diagrams illustrating the configuration of the fuel-gas inlet section of the reactant-gas supplying separator provided in the embodiment shown in FIG. 1;

FIG. 3 is a system diagram depicting a power-generating system having the polymer electrolyte fuel cell according to the embodiment shown in FIG. 1;

FIG. 4 is a diagram for explaining the latent-heat cooling mechanism according to the present invention;

FIG. 5 is a diagram representing the relation between the amount of water supplied to the fuel electrode and the operating temperature of the cell in the present invention;

FIGS. 6A and 6B are diagrams illustrating the configuration of the fuel-gas inlet section of the reactant-gas supplying separator provided in the embodiment shown in FIG. 1;

FIGS. 7A and 7B are diagrams illustrating the configuration of the fuel-gas inlet section of the reactant-gas supplying separator provided in a second embodiment of the present invention;

FIGS. 8A and 8B are diagrams showing the configuration of the fuel-gas inlet section of the reactant-gas supplying separator provided in a third embodiment of the present invention;

FIGS. 9A and 9B are diagrams depicting the configuration of the fuel-gas inlet section of the reactant-gas supplying separator provided in the third embodiment of the invention;

FIGS. 10A and 10B are diagrams showing the configuration of the fuel-gas inlet section of the reactant-gas supplying separator provided in a fourth embodiment of the present invention;

FIGS. 11A and 11B are diagrams showing the configuration of the fuel-gas inlet section of the reactant-gas supplying separator provided in a fifth embodiment of the present invention;

FIG. 12 is a conceptual sectional view showing a basic unit of a conventional polymer electrolyte fuel cell; and

FIG. 13 is a system diagram illustrating a conventional power-generating system with polymer electrolyte fuel cells.

### DETAILED DESCRIPTION OF THE INVENTION

Embodiments of the present invention will be described with reference to the accompanying drawings.

<First Embodiment>

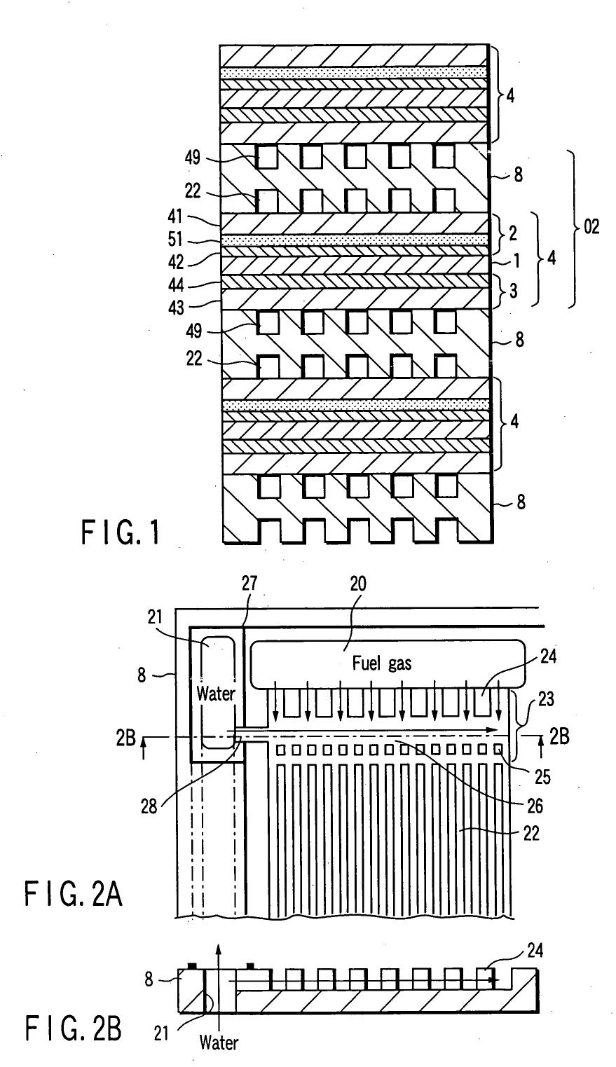

FIG. 1 is a conceptual sectional view for explaining a polymer electrolyte fuel cell according to the first embodiment of the present invention. The fuel-cell main unit 11 of the fuel cell comprises a plurality of basic units 02 that are mechanically laid one on another and electrically connected in series. In FIG. 1, the sealing agent applied between the layers, the gas manifold for supplying reactant gases to each gas-supplying groove, the waver-supplying system, the water manifold and the edges of the layers are not illustrated.

Each basic unit 02 comprises a unit cell 4 and a reactant-gas supplying separator 8. The unit cell 4 is composed of a proton exchange membrane 1, a fuel electrode (electrode) 2 and an oxidizer electrode (electrode) 3. The proton exchange membrane 1 has ionic conductivity. The fuel electrode 2 is mounted on one side of the proton exchange membrane 1 and composed of a substrate 41, a catalyst layer 42 and an electrically conductive porous layer 51 interposed between the substrate 41 and the catalyst layer 42. The catalyst layer 42 is a water-repellant layer. The oxidizer electrode 3 is mounted on the other side of the proton exchange membrane 1 and composed of a substrate 43 and a catalyst layer 44. (The catalyst layers 42 and 43 contact the proton exchange membrane 1.) The reactant-gas supplying separator 8 is a plate and has a plurality of fuel-gas supplying grooves 22 and a plurality of oxidizer-gas supplying grooves 49. The fuel-gas supplying grooves 22 are made in the surface that contacts the substrate 41. The oxidizer-gas supplying grooves 49 are made in the surface that contacts the substrate 43 of the oxidizer electrode 3 of an adjacent unit cell other than said unit cell 4.

A fuel-cell main unit 11 was made by laying such fifty basic units 02 one on another. The proton exchange membrane 1 of each basic unit is made of, for example, Nafion of Dupont, and the substrates 41 and 43 thereof are made of carbon paper having a pore density of, for example, 80%. The porous layer 51 of the fuel electrode 2 is one formed by applying paste to the substrate 41 and heat-treating the paste at 360° C., said paste made of, for example, carbon powder and polytetrafluoroethylene. The catalyst layers 42 and 44 are made of catalyst that comprises carbon and containing 40% of platinum. The reactant-gas supplying separator 8 is a carbon plate having grooves formed by, for example, molding.

The fuel cell according to the first embodiment, thus configured, has no cooling-water supplying separators 7, unlike the conventional fuel cell. Its fuel-cell main unit could therefore be thinner than the conventional fuel-cell main unit by 25%.

In the first embodiment described above, only the fuel electrode 2 has an electrically conductive porous layer 51. Nonetheless, an electrically conductive porous layer may be provided between the substrate 43 and catalyst layer 44 of the oxidizer electrode 3, too.

The configuration of the reactant-gas supplying separator 8 will be described, with reference to FIG. 2. FIG. 2A is a top view outlining the separator 8. FIG. 2B is a sectional view taken along line A-B shown in FIG. 2A. As FIG. 2A shows, a fuel-gas manifold 20 is made in the upper edge part of the separator 8. The manifold 20 is elongated in the transverse direction. It has a plurality of through holes that extend in the direction of thickness of the separator 8. A water manifold 21 is made in another edge part of the separator 8. This manifold 21 is an elongated in the longitudinal direction. The water manifold 21 has a plurality of through holes that extend in the direction of thickness of the separator 8. A plurality of fuel-gas supplying grooves 22 are made in the center part of one surface (upper) surface of the separator 8. The grooves 22 are straight and spaced equidistantly. They extend downwards, each from a point spaced from the fuel-gas manifold 20 by the width of the fuel-gas inlet section 23 that occupies a specific region.

A water-supplying groove 28 is made in one surface (upper surface) of the separator 8. The groove 28 communicates with one of the through holes of the water manifold 21 and with one of the fuel-gas supplying grooves 22. Additionally, a plurality of projections 25 are provided on one surface (upper surface) of the separator 8 and in the fuel-gas inlet section 23. The projections 25 lie at the upper ends of the fuel-gas supplying grooves 22 and are aligned with the centerlines of the grooves 22.

As FIG. 2A depicts, a plurality of partitions 24 are provided on one surface (upper surface) of the separator 8 and positioned adjacent to the fuel-gas manifold 20. The partitions 24 lie between the through holes that constitute the manifold 20. They guide the fuel gas from the manifold 20 to the fuel-gas supplying grooves 22, for the shortest distance possible. The separator 8 thus configured is made by, for example, molding. The partitions 24, projections 25, water-supplying groove 28 and fuel-gas supplying grooves 22 are simultaneously made during the molding process.

In the separator 8 thus configured, the fuel gas is distributed from the fuel-gas manifold 20, or through the through holes made in the separator 8. The fuel gas is thereby supplied to the header 26 that is arranged in the fuel-gas inlet section 23.

Water is distributed by the water manifold 21 that penetrates the separator 8 and supplied from the water-supplying groove 28 to the header 26. In the header 26, the water is mixed with the fuel gas, forming a mixture fluid. The mixture fluid is distributed to the fuel-gas supplying grooves 22.

In the fuel-cell main unit 11 having the basic units 02 laid one on another, the fuel gas and the water are distributed to each separator 8 and then mixed in the heater 26, forming mixture fluid, which is supplied to the fuel-gas supplying grooves 22. The fuel gas and the water can therefore be uniformly distributed to each separator 8.

The water-supplying groove 28 are formed by molding (by pressing and packing powder), at the same time the fuel-gas supplying grooves 22 are made. Hence, the separator can be manufactured at the same cost as the conventional separator.

FIG. 6 is a diagram for explaining a modification of the separator shown in FIG. 2. FIG. 6A is a top view of the separator 8. FIG. 6B is a sectional view taken along line A-B shown in FIG. 6A. To provide water-supplying grooves 28 in greater numbers and to expand the region for the header 26, the fuel-gas manifold 20 and the water manifold 28 are exchanged in position, or set at positions reverse to those shown in FIG. 2. For the same purpose, a plurality of partitions 29 are provided adjacent to the water manifold 21. Since more water-supplying grooves 28 are provided and the region for the header 26 is expanded, the water can be dispersed into the fuel gas more uniformly.

The separator 8 shown in FIG. 2 or FIG. 6 may be either a single separator or may be composed of a fuel-gas supplying separator and an oxidizer-gas supplying separator bonded together. In the first case, the fuel-gas supplying grooves 22 are made in one surface and the oxidizer-gas supplying groove are made in the other surface. In the second case, the fuel-gas supplying separator having fuel-supplying grooves and the oxidizer-gas supplying separator having oxidizer-gas supplying grooves are bonded, back-to-back.

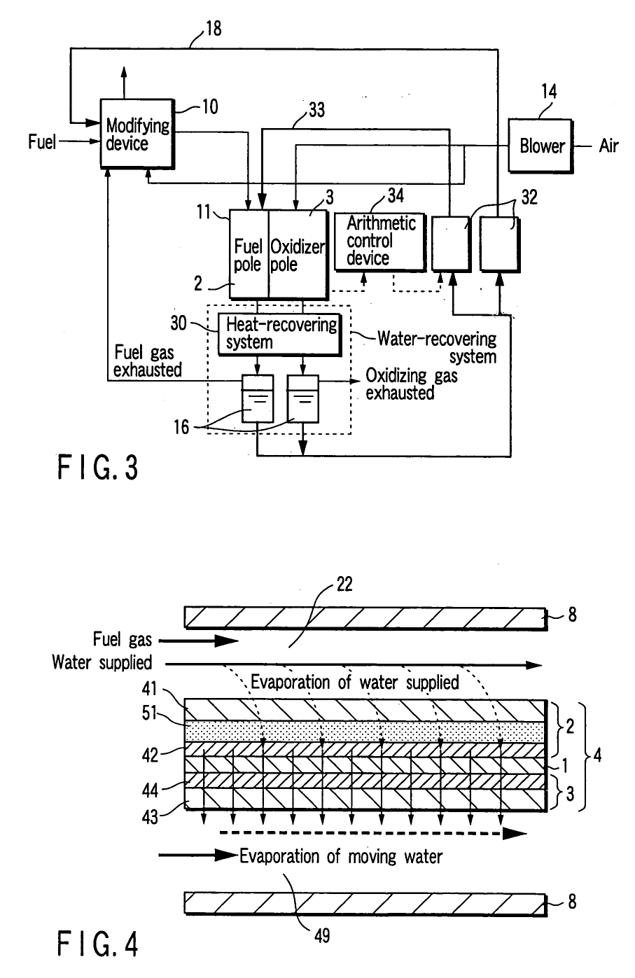

A power-generating system with a fuel-cell main unit of the configuration shown in FIG. 1 and FIG. 2 or FIG. 6, which is an embodiment of the invention, will be described with reference to a system diagram of FIG. 3. Note that the valves for controlling fluids or the devices for measuring temperatures and pressures are not illustrated in FIG. 3.

As FIG. 3 shows, the system does not have the humidifier 12, the water-supplying system 13, cooler 15 or cooling plate 17 as the conventional power-generating system illustrated in FIG. 13. The system has a heat-recovering system 30, an arithmetic/control device 34, diaphragm-type metering pumps 32, and a staked water-supplying line 33.

The heat-recovering system 30 constitutes a water-recovering means according to the present invention. It is provided on, for example, the pipes that connect the fuel electrode 2 and oxidizer electrode 3 of the fuel-cell main unit 11 to drain pots 16, respectively. It recovers heat from the exhausted fuel gas that is discharged from the fuel-cell main unit 11. It also recovers heat from the oxidizer exhaust gas that is discharged from the unit 11.

The arithmetic/control device 34 constitutes a water-amount control means according to the present invention. It calculates an amount of water supplied, from the voltage of the power generated and load current in the fuel-cell main unit 11. How it calculates the amount of water will be later described in detail.

One of the metering pumps 32 is provided on a modified-water supplying line 18 that connects the drain pots 16 to a reformer 10. The other metering pump 32 is provided on the stacked water-supplying line 33 that connects the drain pots 16 to the fuel electrode 2 of the fuel-cell main unit 11. The metering pump 32 controls the amount in which the recovered water should be supplied, in accordance with a signal that represents the result of the calculation that the arithmetic/control device 34 has performed.

In the structure shown in FIGS. 1 to 3 and FIG. 6, the water manifold 21, fuel-gas supplying grooves 22, fuel-gas inlet section 23, header 26, water-supplying grooves 28 and a porous member 50 constitute a water-supplying means. The porous member 50 will be described later.

In the system of this configuration, methanol is used as fuel and reformed in the reformer 10 to fuel gas that consists mainly of hydrogen gas. The fuel gas is supplied to the fuel-cell main unit 11. The heat-recovering system 30 cools the reacted fuel gas from the fuel-cell main unit 11. Water is recovered from the fuel gas. Then the fuel gas is combusted in the reformer 10 and released into the atmosphere.

Meanwhile, the atmospheric air is supplied, as oxidizer gas, directly to the fuel-cell main unit 11. The heat-recovering system 30 cools the oxidizer gas exhausted from the fuel-cell main unit 11. Water is recovered from the oxidizer gas. Then the oxidizer gas is released into the atmosphere. The water recovered from the exhausted fuel gas and exhausted oxidizer gas is collected in the drain pots 16. One metering pump 32 supplies the water to the fuel electrode 2 of the fuel-cell main unit 11. The other metering pump 32 supplies the water to the reformer 10.

The arithmetic/control device 34 controls the amount of water to be supplied to the fuel-cell main unit 11. The arithmetic/control device 34 finds the lowest flow rate W for water in accordance with the equation (13), from the voltage of the electric power generated by the fuel-cell main unit 11 and from the load current I, which have been measured. The arithmetic/control device 34 then controls the vibration frequency for the diaphragm pumps so that water may be supplied to the fuel-cell main unit 11 at a rate twice the in an amount twice the lowest flow rate W.

W=30·I·C·(ΔH/F−2V)/h (13)

where W is the lowest flow rate for water (g/min), V is the voltage of electric power (V/cell), I is the load current (A), C is the number of basic units stacked, h is the latent heat of evaporation (J/g), ΔH is the enthalpy change (J/mol) that occurs when water the cell reaction generates water vapor, and F is the Faraday constant (C/mol). The power-generating system described above was activated at normal temperature. As the load current is extracted from the fuel-cell main unit, the temperature of the fuel-cell main unit 11 gradually rose. It became stable at about 77° C. when the system was operated at load current of 0.4 A/cm² (116A), fuel use ratio of 70% and use ratio of air of 40%. The cell voltage in this condition was 0.7 V/cell.

At the operating conditions specified above, the lowest flow rate for water is 85 cc/min on the basis of the equation (13). Thus, the water was supplied at the rate of 170 cc/min. Water must be supplied at the rate of 1528 cc/min in order to take away the same amount of heat by using the sensible heat of cooling water if the temperature difference is 3° C. The amount of water that should be supplied to achieve complete latent heat cooling is, therefore, extremely small.

The temperature of the fuel-cell main unit changed in the range of 74° C. to 80° C. with the changes in the operating conditions such as the dew point of the air supplied, the temperature of the water supplied, the ambient temperature, the load current and the use ratio of air. At whichever temperature, the fuel-cell main unit underwent complete latent heat cooling and achieved stable operation to generate electric power. When the load current varied in the range of 0.1 A/cm² (29A) to 1 A/cm² (290A), the amount of water supplied changed in the range of 35 cc/min to 542 cc/min. Thus, the water could perform complete latent heat cooling on the fuel-cell main unit.

The mechanism of the latent heat cooling will be explained with reference to FIG. 4. Part of the water supplied along with the fuel gas changes into water vapor in the fuel-gas supplying grooves 22. The water vapor flows through the electrically conductive porous layer 51 that is a water-repellant layer provided in the fuel electrode 2. The water vapor then reaches the catalyst layer 42. In the catalyst layer 42 of the fuel electrode 2, the water vapor condenses and changes to water, as the fuel gas is consumed. The water thus formed passes through the proton exchange membrane 1 and moves to the oxidizer electrode 3. The water then evaporates at the oxidizer electrode 3.

Therefore, the proton exchange membrane 1 always remains wet (humidified or maintained ΔH humid). This makes it unnecessary to humidify the oxidizer gas. The porous layer 51 provided in the fuel electrode 2 plays an important role. The porous layer 51 allows water vapor to pass through it easily, but prevents water from passing through it. Hence, when an excessive amount of water is supplied through the fuel-gas supplying grooves 22, a sufficient amount of water can be supplied to evaporate at the oxidizer electrode 3. A voltage drop can yet be prevented, which may occur if the water supplied in an excessive amount leaks from the catalyst layers 42 and 44.

The experimental results show that the cell voltage gradually fell as time passes during the operation, in the case of a fuel electrode that had no porous layer 51. This is probably because the catalyst layers 42 and 44 were wetted with water to excess, causing prominent polarization.

Meanwhile, the water moved to the electrode 3 and the water generated in the cell reaction evaporates in the oxidizer electrode 3. When the water evaporates, it absorbs the latent heat of evaporation, which is 539 cal/g. Therefore, the air absorbs the heat generated in the cell reaction, thus achieving latent heat cooling on the fuel-cell main unit 11. The air is then discharged from the fuel-cell main unit 11.

The efficiency of latent heat cooling depends on the amount in which water evaporates in the fuel-cell main unit 11. The higher the temperature of the fuel-cell main unit 11, the greater the difference between the temperature of the unit 11 and the dew point of the air supplied, and the lower the use ratio of air, the larger the amount of water that evaporates and, hence, the higher the efficiency of latent heat cooling.

Thus, if the dew point of the air supplied and the use ratio of air remain constant, the degree of latent heat cooling is low when the fuel-cell main unit 11 has a low temperature. As a result, the temperature of the fuel-cell main unit 11 rises. When the temperature of the fuel-cell main unit 11 rises sufficiently, the degree of latent heat cooling increases and is eventually balanced with the amount of heat generated by the fuel-cell main unit 11. In this case, the temperature of the fuel-cell main unit 11 becomes constant. Even if the operating conditions such as the dew point of air, load current, use ratio of air and ambient temperature change, the temperature of the fuel-cell main unit 11 will change until the amount of heat generated is balanced with the degree of latent heat cooling. Then, the temperature of the unit 11 becomes stable even if no external control of temperature is carried out.

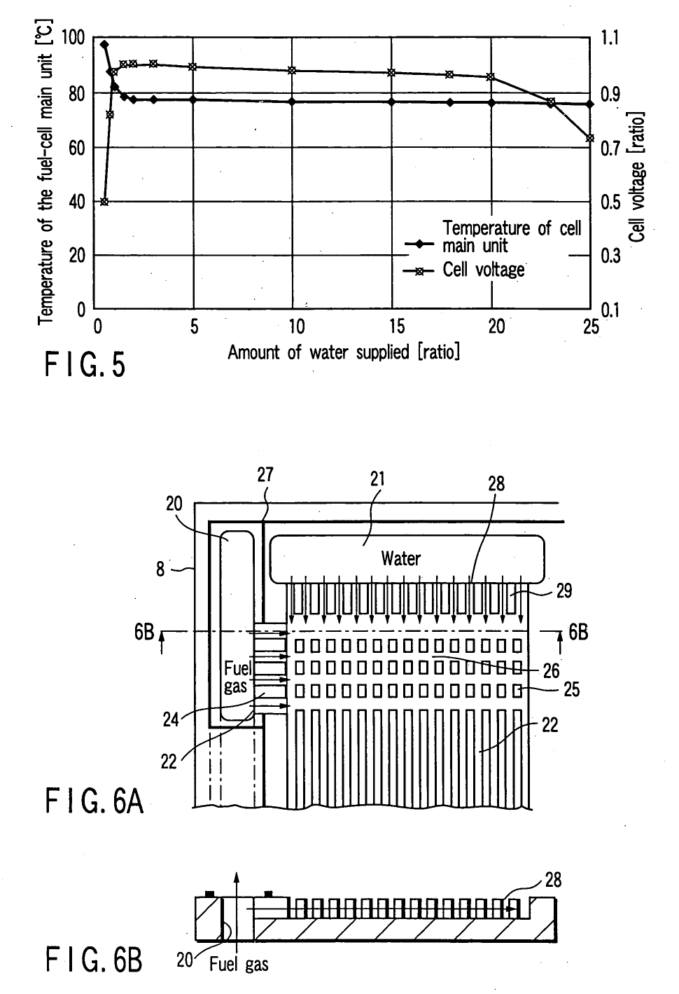

The relation between the amount of water supplied to the fuel electrode 2, the operating temperature of the cell and the cell voltage will be explained, with reference to FIG. 5. In FIG. 5, the amount W of water is 1, which water has latent heat corresponding to the heat calculated from the voltage of power generated and the load current, on the assumption that all water generated through the cell reaction in the fuel-cell main unit 11 turns into water vapor. The amount of water supplied to the fuel electrode is plotted on the abscissa, while the temperature of the fuel-cell main unit and the cell voltage are plotted on the ordinate. Of the operating conditions of the present embodiment, the lowest flow rate W for water was 85 cc/min.

As evident from FIG. 5, the temperature of the fuel-cell main unit abruptly rose when the amount of water supplied was 1 or less. This is probably because the water less evaporated at the oxidizer electrode 3 and the latent heat cooling became less prominent. At this time, the proton exchange membrane 1 was rater dried. Therefore, the cell resistance increased and the cell voltage sharply decreased.

When the amount of water supplied was 1 to 20 times, the temperature of the fuel-cell main unit was almost constant and the cell voltage was stable. This indicates that the air at the oxidizer electrode 3 was saturated nearly 100% when the amount of water supplied was 1 or more, achieving sufficient latent heat cooling. That is, the fuel-cell main unit 11 had undergone complete latent heat cooling.

When the amount of water supplied exceeded 20 times, the cell voltage tended to decrease abruptly. This is perhaps because the water supplied in excess prevents hydrogen to diffuse, promoting polarization at the fuel electrode 2. In view of this, water was supplied to the fuel-cell main unit 11 in an amount ranging from a value to 20 times this value, said value corresponds to an amount of heat calculated from the voltage of power generated and the load current on the assumption that all water generated in the cell reaction in the polymer electrolyte fuel-cell main unit turns into water vapor. The proton exchange membrane 1 therefore remained wet. As a result, the fuel-cell main unit 11 could be subjected to complete latent heat cooling, outputting stable electric power.

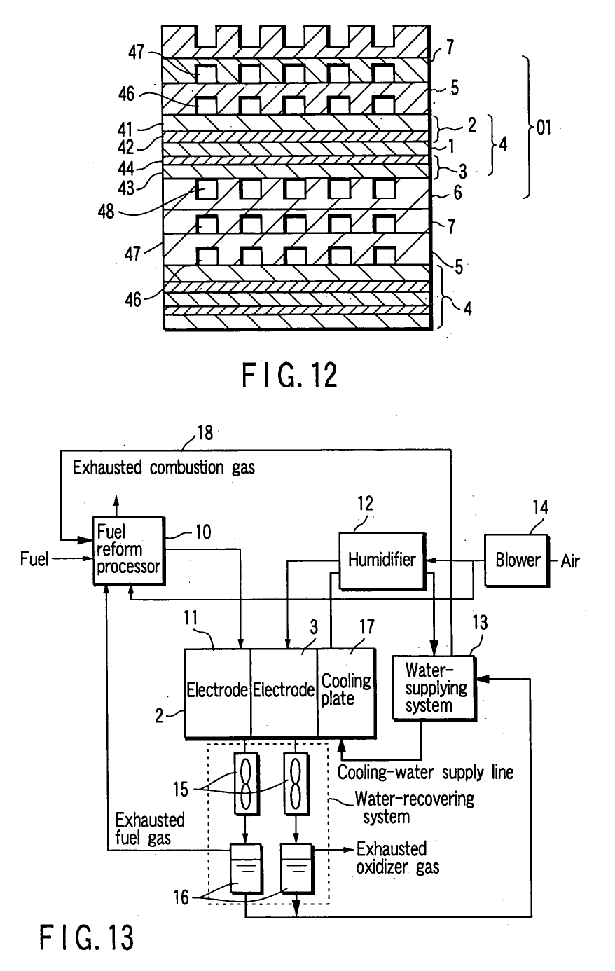

The first embodiment does not need a cooling-water supplying separator 7 as the conventional fuel cell, because water is supplied in a prescribed amount to the fuel electrode 2 of the fuel-cell main unit 11. The fuel-cell main unit 11 can be compact. It was confirmed that the proton exchange membrane 1 remained wet to perform complete latent heat cooling on the fuel-cell main unit 11, enabling the unit 11 to operate well even when the load greatly changed. This means that latent heat cooling can be achieved without using the cooling-water supplying separators 7 shown in FIG. 12.

The power-generating system with the fuel-cell main unit 11 need not have a humidifier 15 that is required in the conventional power-generating system. Thus, water needs to be supplied for latent heat cooling, but in an amount far smaller than in the conventional power-generating system. The power-generating system of the invention can therefore be made compact and lightweight.

<Second Embodiment>

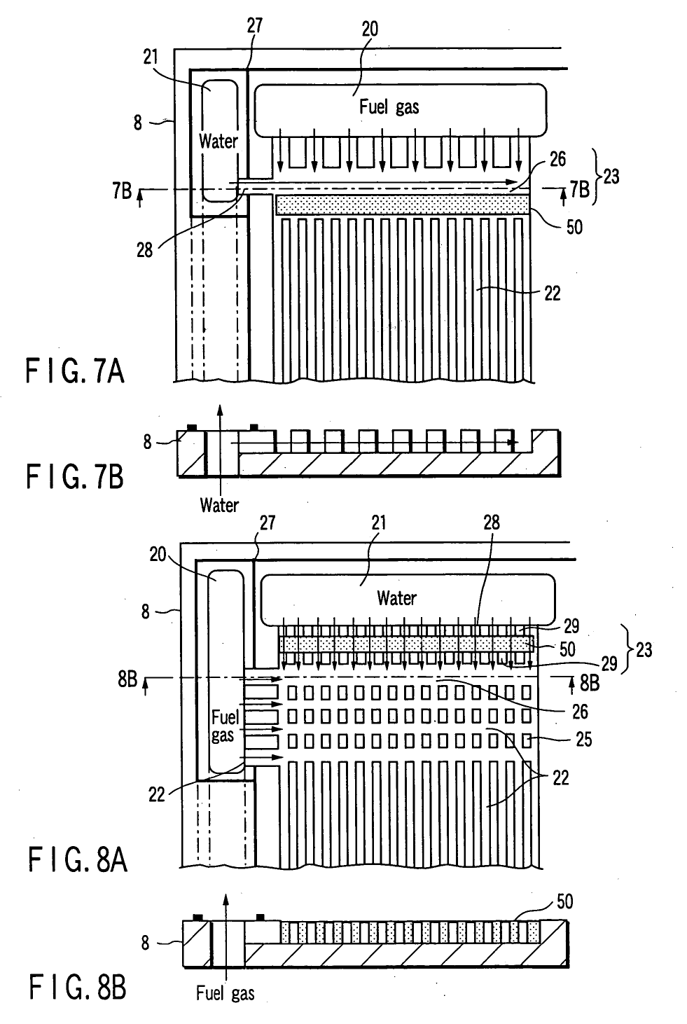

FIG. 7 is a diagram illustrating a second embodiment of the present invention. FIG. 7A is a top view schematically showing a separator 8. FIG. 7B is a sectional view taken along line A-B shown in FIG. 7A. As FIG. 7A shows, the separator 8 is a reactant-gas supplying separator that has a porous member 50 that is provided on a header 26. The porous member 50 is used as a pressure-loss element (member for achieving a uniform flow of fluid). In any other respect the separator 8 is identical to the separator of FIG. 2.

The porous member 50 may be made of any material having through pores, such as composite material, unwoven fabric, sintered bodies, meshes or the like. It is preferred that the member 50 be made of carbon material that is resistant to corrosion and comparatively inexpensive.

Therefore, fuel gas passes through the separator 8 and is distributed by the fuel-gas manifold 20 to the header 26 that is provided in the fuel-gas inlet section 23. Water passes the separator 8, too, and is distributed by the water manifold 21 to the header 26 through the water-supplying grooves 28. The fuel gas and water, thus supplied, mix with each other, forming a mixture fluid. The mixture fluid passes through the porous member 50 and is distributed to the fuel-gas supplying grooves 22. The porous member 50 is made of sintered metal that has pores whose average diameter is 500 mm.

In the second embodiment, the mixture fluid consisting of the water and the fuel gas dispersed in a direction perpendicular to the flow due to the pressure loss that develops as the mixture fluid passed through the porous member 50. In the fuel-cell main unit 11, the water and the fuel gas mixed uniformly even when the fuel gas was supplied at high rate at the load current density of 1 A/cm². Thus, it was possible to generate electric power in a stable condition.

<Third Embodiment>

FIG. 8 is a diagram illustrating a third embodiment of the present invention. FIG. 8A is a top view schematically showing a separator 8. FIG. 8B is a sectional view taken along line A-B shown in FIG. 8A. As FIG. 8A depicts, each partition 29 of the reactant-gas supplying separator 8 is cut in the middle, and a porous member 50 is provided, extending between the halves of each partition 29 and connecting the partitions 29 to one another. The porous member 50 is used as a pressure-loss element as in the case shown in FIG. 7. In any other respect the separator 8 is identical to the separator of FIG. 6.

Therefore, the fuel gas is distributed from the gas manifold 20 that passes through the separator 8 and is supplied to the header 26 arranged in the fuel-gas inlet section 23. Water is distributed from the water manifold 21 that passes through the separator 8 and is supplied to the header 26 though the water-supplying grooves 28. In the header 26, the water and the fuel gas are mixed, forming a mixed fluid. The mixed fluid passes through the porous member 50 and is distributed into the fuel-gas supplying grooves 22.

In the third embodiment, water was supplied from the water-manifold 21 to the header 26 through the porous member 50 that extends across the water-supplying grooves 28. The water was therefore dispersed well in the header 26 and can be uniformly mixed with the fuel gas. This made it possible to supply the resultant mixed fluid uniformly into the fuel-gas supplying grooves 22.

Moreover, in the fuel-cell main unit 11, the water and the fuel gas mixed uniformly even when the fuel gas was supplied at high rate and load current density of 1 A/cm². Thus, it was possible to generate electric power in a stable condition.

The porous member 50 extending across the water-supplying grooves 28 that constitute the water-supplying section was made of unwoven fabric having pores whose average diameter was 20 gμ. The supply of water was stopped to cope with troubles that might occur during the power generation. At this time, the fuel gas pressure in the gas manifold 20 rose to a value 5 kPa higher than the pressure in the water manifold 21. No fuel gas leaked into the water manifold 21, nonetheless.

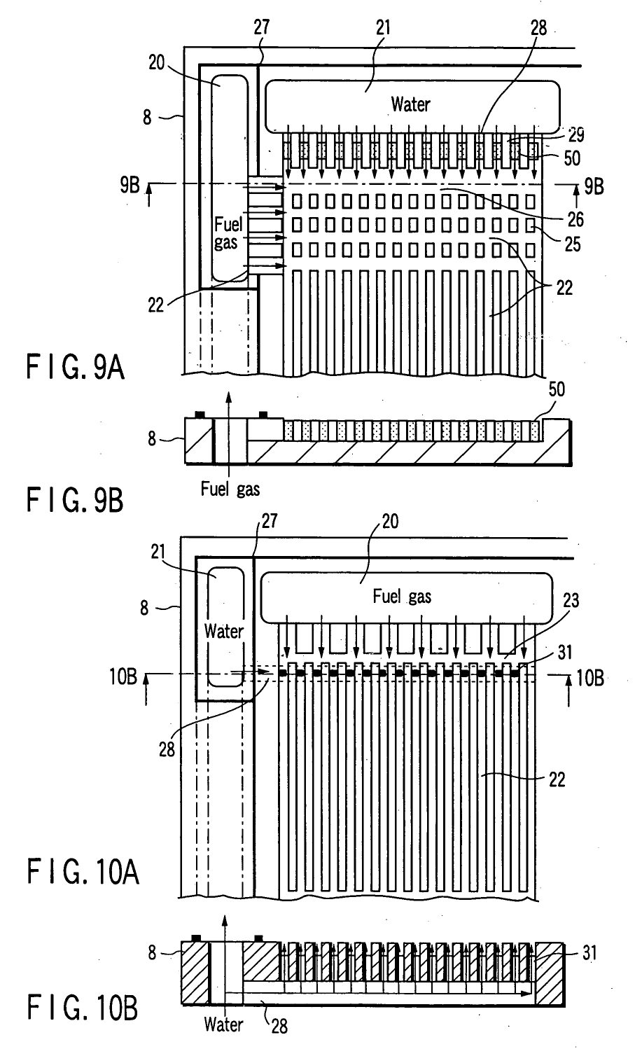

FIG. 9 is a diagram illustrating a modification of the third embodiment. FIG. 9A is a top view schematically showing a separator 8. FIG. 9B is a sectional view taken along line A-B shown in FIG. 9A. As FIG. 9 shows, porous members 50 are provided, each between adjacent two partitions 29 provided in the separator 8. The porous members 50 are used as pressure-loss elements as in the case shown in FIG. 7. In any other respect the separator 8 is identical to the separator of FIG. 6. The modification shown in FIG. 9 can attain the same functional advantages as the embodiment shown in FIG. 8.

<Fourth Embodiment>

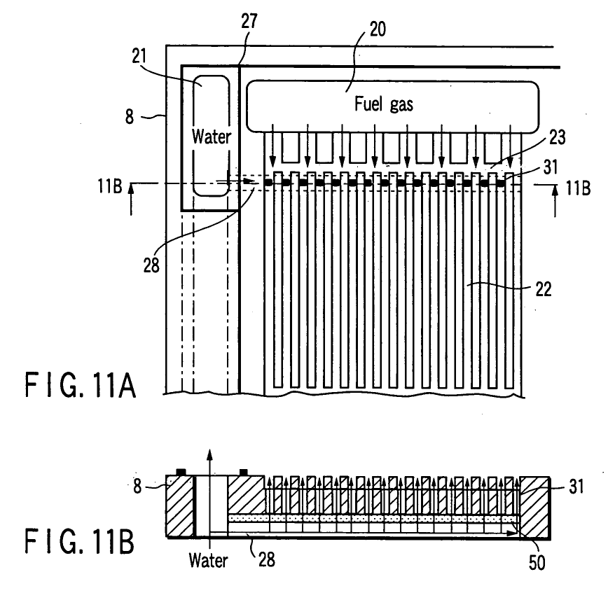

FIG. 10 is a diagram illustrating a fourth embodiment of the present invention. FIG. 10A is a top view schematically showing a separator 8. FIG. 10B is a sectional view taken along line A-B shown in FIG. 10A. In this embodiment, the reactant-gas supplying separator 8 have no projections 25, unlike in the embodiment of FIG. 2. The fuel-gas supplying grooves 22 extend to the positions of the projections provided in the second embodiment. A water-supplying groove 28 is made in the surface facing away from the surface in which the fuel-gas supplying grooves 22 are made and on which the fuel-gas inlet section 23 is provided. The water-supplying groove 28 communicates with the water manifold 21. The separator 8 has a plurality of communication holes 31, which are spaced apart at regular intervals and connect the fuel-gas inlet section 23 to the water-supplying groove 28. The communication holes 31 are provided, each for one fuel-gas supplying groove 22. The holes 31 have a diameter of, for example, 0.5 mm. In any other respect the separator 8 is identical to the separator of FIG. 2.

In the fourth embodiment, water was supplied directly into the fuel-gas supplying grooves 22 as described above. This made it possible for the water to mix well with the fuel gas. The resultant mixture fluid was uniformly supplied into the fuel-gas supplying grooves 22 in the plane of the separator.

In addition, the water and the fuel gas mixed uniformly even when the fuel gas was supplied at high rate at the load current density of 1 A/cm². It was therefore possible to generate electric power in a stable condition. Neither the number of the communication holes 31 nor the diameter thereof is limited to the value specified above. The holes 31, if provided in any other number and any other diameter, they can achieve the same advantage. The smaller the diameter of the holes 31, the better. In practice, however, the diameter depends upon the technique of making the fuel-gas supplying grooves 22.

<Fifth Embodiment>

FIG. 11 is a diagram depicting a fifth embodiment of the present invention. FIG. 11A is a top view schematically showing a separator 8. FIG. 11B is a sectional view taken along line A-B shown in FIG. 11A. In this embodiment, porous members 50 used as pressure-loss elements as in the embodiment of FIG. 7 are provided in the water-supplying groove 28 and covers the communication holes 31. The water-supplying grooves 28 are made in that surface of the separator 8 which faces away from the surface in which fuel-gas supplying grooves 22 are made.

In this case, the communication holes 31 had a diameter of 9 mm. The porous members 50 was made of unwoven carbon fabric having a thickness of 50 μm and an average pore diameter of 10 μm.

With this embodiment it was possible to mix water with the fuel gas uniformly and to distribute the mixture fluid uniformly into the gas-supplying grooves. Further, electric power could be generated in a stable condition even when the fuel gas was supplied at high rate at the load current density of 1 A/cm². The pressure of the fuel gas in the gas manifold 20 was set to a value 8 kPa higher than the pressure in the water manifold 21 in order to cope with troubles that might occur during the power generation. Nonetheless, no fuel gas leaked into the water manifold 21.

The invention described above is advantageous in that the proton exchange membrane is prevented from being dried even if the reactant gases are not humidified beforehand. This is because, in the fuel-cell main unit comprising a stack of unit cells, a water-supplying means supplies water to the fuel-gas inlet section connected to the fuel-gas supplying grooves, namely water is supplied to the fuel-gas inlet section. This is also because a humidifying/latent-heat cooling means is provided to humidify the proton exchange membrane and perform latent heat cooling on the reactant-gas supplying separator. Thus, the invention can provide a fuel-cell main unit that can generate electric power in a stable condition even if the load increases or greatly changed. The present invention can achieve other advantages that will be described below.

(1) The fuel-cell main unit can be compact and lightweight, because it does not have a cooling-water supplying separator that is required in the conventional fuel-cell main unit.

(2) The water-supplying system can be compact and lightweight, because it does not have a cooling-water supplying separator hitherto required to cool the fuel-cell main unit.

(3) A large humidifier does not need to be used as is hitherto required. This is because the proton exchange membrane will not be dried even if it the oxidizer gas is not humidified beforehand.

Since the water-supplying means is provided by processing at least one surface of the reactant-gas supplying separator, the fuel-cell main unit can become compact and lightweight. This greatly reduces the manufacturing cost of the fuel-cell unit.

Moreover, the porous member that is provided between the catalyst layer of the fuel electrode and the fuel-gas supplying grooves and constitutes a water-repellant layer prevents flooding at the fuel electrode even if water us supplied to the fuel electrode in an excessive amount. This broadens the range of amount in which water can be supplied. The appropriate flow rate for water from the voltage V (V/cell) of the electric power generated and from the load current I (A) is applied to control the flow rate of the water being supplied to the fuel-cell main unit. Hence, water is supplied neither insufficiently nor excessively even when the load greatly changes. The fuel cell can therefore operate in a stable condition.

As has been described, the present invention can provide a polymer electrolyte fuel cell and a power-generating system with polymer electrolyte fuel cells, which can be compact and lightweight, operate with high reliability and be manufactured at a low cost.

<Modification>

The present invention is not limited to the embodiments described above. It can be used in practice in the form of the following modified embodiments. In each embodiment, the reactant-gas supplying separator 8 in each embodiment has fuel-gas supplying grooves 22 made in one surface and oxidizer-gas supplying grooves 49 made in the other surface. Instead, the separator 8 may comprise two parts either coupled to each other or abutting on each other, one part having fuel-gas supplying grooves 22 and the other part having oxidizer-gas supplying grooves 49. As far as FIG. 1 shows, each reactant-gas supplying separator interposed between two adjacent unit cells has fuel-gas supplying grooves 22 and oxidizer-gas supplying grooves 49. Needless to say, the reactant-gas supplying separator provided at one end of a unit cell, or at the vessel of the unit cell, has only fuel-gas supplying grooves or only oxidizer-gas supplying grooves.

In the embodiments, the fuel-gas supplying grooves 22 and oxidizer-gas supplying grooves 49 of the reactant-gas supplying separator 8 are holes in which porous members are provided as pressure-loss elements. Instead, they may be replaced by fuel-gas supplying passages and oxidizer supplying passages which are tubes, in which porous members are provided as pressure-loss elements.

In the embodiments, fuel-gas supplying grooves are provided to supply water to the fuel-gas inlet section. The positions to which the water is supplied may be the midpoints on, for example, the fuel-gas supplying grooves that constitute fuel-gas supplying passages.

The polymer electrolyte fuel cell and the power-generating system with polymer electrolyte fuel cells, both according the present invention, can be utilized as stationary power supplies or as power supplies for use in, for example, vehicles.

What is claimed is:

1. A polymer electrolyte fuel cell comprising:
a plurality of unit cells each having a proton exchange membrane, a fuel electrode provided on one surface of the membrane and having a catalyst layer, and an oxidizer electrode provided on the other surface of the membrane and having a catalyst layer;
a reactant-gas supplying separator having reactant gas supplying passages for supplying reactant gas to the fuel electrode and oxidizer electrode of each unit cell;
a water manifold passing through the reactant gas supplying separator; and
water-supplying means for supplying water in liquid state to the reactant gas supplying passages provided in at least one of the fuel electrode and oxidizer electrode, said water-supplying means comprising a header which is provided in a reactant gas inlet section provided in the reactant gas supplying separator and which mixes reactant gas with water, and a water-supplying groove which is made in the same surface of the reactant gas supplying separator as the reactant gas supplying passages and which connects the header and the water manifold.

2. The polymer electrolyte fuel cell according to claim 1, comprising: a plurality of unit cells each having proton exchange membrane, a fuel electrode provided on one surface of the membrane and having a catalyst layer, and an oxidizer electrode provided on the other surface of the membrane and having a catalyst layer; a reactant gas supplying separator having fuel-gas supplying passages for supplying reactant gas to the fuel electrode to the fuel electrode and oxidizer electrode of each unit cell; a water manifold which passes through at least the reactant-gas supplying separator, water-supplying means for supplying water in liquid state to reactant gas supplying passages which are made in at least one of the fuel electrode and oxidizer electrode, said water-supplying means comprising a header which is provided in a reactant-gas inlet section provided in the reactant-gas supplying separator and which mixes reactant-gas with water, a water-supplying groove which is made in the same surface as the reactant gas supplying passages and which connects the header and the water manifold, and a porous member; a water-supplying groove which is made in the same surface as the reactant gas supplying passages and which connects the header and the water manifold, and; a porous member which is arranged in the water-supplying groove and which has an average pore diameter of 20 m or less (excluding 0 mm).

3. A power-generating system with polymer electrolyte fuel cells, comprising:
a plurality of unit cells each having a proton exchange membrane, a fuel electrode provided on one surface of the membrane and having a catalyst layer, and an oxidizer electrode provided on the other surface of the membrane and having a catalyst layer;
a reactant-gas supplying separator having reactant gas supplying passages for supplying reactant gas to the fuel electrode and oxidizing electrode of each unit cell;
a water manifold which passes through the reactant gas supplying separator; and
water-supplying means for supplying water in liquid state to the reactant gas supplying passages made in at least one of the fuel electrode and oxidizer electrode;
heat-recovering means for recovering heat of water from exhausted fuel gas and oxidizer exhaust gas which are discharged from the unit cells;
recovered-water supplying means for supplying the water recovered in the heat-recovering means; and
water-amount control means for controlling an amount of water supplied from the recovered-water supplying means.

4. A power-generating system with polymer electrolyte fuel cells, comprising: a plurality of unit cells, each having proton exchange membrane, a fuel electrode provided on one surface of the membrane and having a catalyst layer, and an oxidizer electrode provided on the other surface of the membrane and having a catalyst layer; a reactant gas supplying separator having reactant gas supplying passages for supplying reactant gases to the fuel electrode and oxidizing electrode of each unit cell; a water manifold which passes through the reactant gas supplying separator; water-supplying means for supplying water in liquid state to the reactant gas supplying passages made in at least one of the fuel electrode and oxidizer electrode; heat-recovering means for recovering heat of water from exhausted fuel gas and exhausted oxidizer gas which are discharged from the unit cells; recovered-water supplying means for supplying the water recovered in the heat-recovering means to the unit cells; and water-amount control means for controlling an amount of water supplied from the recovered water supplying means, wherein calculation means for calculating an amount of water to be supplied, from the voltage of electric power generated by each unit cell and the load current of each unit cell, and a metering pump which controls the amount of the recovered water to be supplied, in accordance with a signal representing the result of calculation performed by the calculation means.

5. A power-generating system with polymer electrolyte fuel cells, comprising: a plurality of unit cells, each having proton exchange membrane, a fuel electrode provided on one surface of the membrane and having a catalyst layer, and an oxidizer electrode provided on the other surface of the membrane and having a catalyst layer; a reactant gas supplying separator having reactant gas supplying passages for supplying reactant gases to the fuel electrode and oxidizing electrode of each unit cell; a water manifold which passes through the reactant gas supplying separator; water-supplying means for supplying water in liquid state to the reactant gas supplying passages made in at least one of the fuel electrode and oxidizer electrode; heat-recovering means for recovering heat of water from exhausted fuel gas and exhausted oxidizer gas which are discharged from the unit cells; recovered-water supplying means for supplying the water recovered in the heat-recovering means to the unit cells; and water-amount control means for controlling an amount of water supplied from the recovered water supplying means, said water-amount control means comprising calculation means which calculates an amount of water to supply, from the voltage of electric power generated by each unit cell and the load current of each unit cell, wherein the calculation means calculates the amount W of water (g/min) in accordance with the following equation, and the water-amount control means controls the supply of water to the fuel-gas supplying passages or oxidizer-gas supplying passages, in an amount up to 20 times the value W,
W=30·I·C·(ΔH/F−2V)/h (1)
where V is the voltage of electric power (V/cell), I is the load current (A), C is the number of basic units stacked, h is the latent heat of evaporation (J/g), DH is the enthalpy change (J/mol) that occurs when water the cell reaction generates water vapor, and F is the Faraday constant (C/mol).
